(19) United States
(12) Patent Application Publication
(10) Pub. No.: US 2004/0213125 A1
(43) Pub. Date: Oct. 28, 2004

(54) Optical recording medium

(75) Inventors: Hiroshi Shingai, Tokyo (JP); Hiroshi Chihara, Tokyo (JP); Hideki Hirata, Tokyo (JP)

Correspondence Address: GREENBLUM & BERNSTEIN, P.L.C., 1950 ROLAND CLARKE PLACE, RESTON, VA, 20191, US

(73) Assignee: TDK Corporation, Tokyo (JP)

(21) Appl. No.: 10/829,355

(22) Filed: Apr. 22, 2004

(30) Foreign Application Priority Data
Apr. 24, 2003 (JP) 2003-120205

(51) Int. Cl. G11B 7/24

(52) U.S. Cl. 369/94; 369/288

(57) ABSTRACT

An optical recording medium includes a phase-change recording layer where reversible phase changes between a crystal phase and an amorphous phase are used. The recording layer includes at least Sb, Tb, and Te. When indexing as a hexagonal lattice has been performed in a state corresponding to the crystal phase, the recording layer has a structure where an axial ratio c/a of a c-axis length to an a-axis length in the hexagonal lattice is between 2.590 and 2.702 inclusive.

### BACKGROUND OF THE INVENTION

1. Field of the Invention

This invention relates to an optical recording medium that has a phase-change recording layer.

2. Description of the Related Art

Optical recording media that are capable of high-density recording and on which recorded information can be overwritten have been subject to much attention in recent years. Information is recorded on phase-change optical recording media, which are one example of such rewritable optical recording media, by changing the crystal state of a recording layer through irradiation with laser beam. Recorded information is reproduced by detecting changes in the reflectivity of the recording layer due to such changes in the crystal state. Phase-change optical recording media have been subject to particular attention since it is possible to rewrite the recorded information by modulating the intensity of a single laser beam and to record and reproduce information using an optical system with a simpler construction than an optical system used with magneto-optical recording media.

GeTe, GeTeSe, GeTeS, GeSeS, GeSeSb, GeAsSe, InTe, SeTe, SeAs, Ge—Te—(Sn,Au,Pd), GeTeSeSb, Ge—Sb—Te, Ag—In—Sb—Te, and the like are known as recording materials that can compose a phase-change recording layer. Especially recently, chalcogenide compounds, such as Ge—Sb—Te materials and Ag—In—Sb—Te materials, that include elements (chalcogens) belonging to group VIb, such as Te and Se, in addition to the main constituent Sb have been used for reasons such as the large difference in the reflectivity between the crystal state and the amorphous state and their relatively high stability in the amorphous state.

Usually, when information is recorded on a rewritable phase-change optical recording medium, the entire recording layer is first initialized (i.e., placed in the crystal state) and the recording layer is then irradiated by laser beam set at a high power (the “recording power”) capable of raising the temperature of the recording layer to the melting point or above. By doing so, amorphous recording marks are formed at the positions that were irradiated by the laser beam of the recording power through rapid cooling after the recording layer has melted. On the other hand, recording marks that have been formed are erased by irradiating the marks with a laser beam with a power (“erasing power”) that is capable of raising the temperature to the crystallization temperature of the recording layer or above. The recording marks (amorphous parts) are restored to the crystal state (i.e., the recording marks are erased) by slowly cooling the parts that were irradiated by the laser beam of the erasing power after the recording layer has been heated to the crystallization temperature or above. In this way, by modulating the intensity of a single beam, it is possible to perform rewrites on a rewritable phase-change optical recording medium.

As one example, a phase-change recording layer including a metastable Sb₃Te phase, which includes Sb and Te and belongs to a space group Fm3m, is disclosed in Japanese Laid-Open Patent Publication No. 2000-43415. This Sb₃Te phase has a face centered cubic (f.c.c.) structure and in the cited publication, recording is performed at a linear velocity of 7 m/s using a laser beam with a wavelength of 635 nm.

Japanese Laid-Open Patent Publication No. 2000-313170 discloses a phase-change recording layer with a composition that includes Sb, Te, and Ge, and is expressed as ((SbₓTe₁₋ₓ)_{y} Ge_{1-y})_{z}M_{1-z}. This publication states that in the crystal state, the recording layer should preferably be composed of a crystal phase with a face-centered cubic structure, and in this case, a structure with a single crystal phase or a plurality of crystal phases may be used, though when there is a plurality of crystal phases, there should preferably be no lattice mismatching. In addition, in the embodiments of the same publication, recording is performed using a laser beam with a wavelength of 780 nm, with the linear velocity varying between 1.2 m/s and 8.1 m/s.

However, by investigating optical recording media with the recording layers described in these references, the present inventors discovered the following problem. In recent years, to achieve a high recording density and a high transfer rate, the wavelength of the laser beam irradiated during recording and reproduction has been reduced, the numerical aperture of the objective lens of a recording/reproduction optical system has been increased, and media have been rotated at higher linear speeds. In this case, the spot diameter of the laser beam on the surface of the recording layer is expressed as λ/NA where λ is the laser wavelength and NA is the numerical aperture, and the laser irradiation time (that is, the time required for the beam spot to pass) on the recording layer is given by this spot diameter λ/NA divided by the linear velocity V of the medium (that is, (λ/NA)/V). Accordingly, as the recording density and transfer rate are increased, the laser irradiation time on the recording layer becomes progressively shorter. This means that the optical recording medium needs to have a recording layer with a high crystallization speed so that crystallization can be performed reliably even when the irradiation time of a laser beam is short. Also, the recording layer needs to stably store the recorded recording information regardless of environmental changes, that is, the recording layer needs to have superior thermal stability in the amorphous state. However, the recording media disclosed by Japanese Laid-Open Patent Publication Nos. 200-43415 and 200-313170 mentioned above do not consider the use of a laser beam with a short wavelength of around 400 nm as the light source, and have linear velocities that at 10 m/s or below are extremely slow, resulting in the problem of these recording media being incompatible with recording at high densities and high transfer rates.

### SUMMARY OF THE INVENTION

The present invention was conceived to solve the problems described above and it is a principal object of the present invention to provide an optical recording medium that is compatible with a high transfer rate and has superior thermal stability in an amorphous state.

To achieve the stated object, the optical recording medium according to the present invention includes a phase-change recording layer where reversible phase changes between a crystal phase and an amorphous phase are used, wherein the recording layer includes at least Sb, Tb, and Te and when indexing as a hexagonal lattice has been performed in a state corresponding to the crystal phase, the recording layer has a structure where an axial ratio c/a of a c-axis length to an a-axis length in the hexagonal lattice is between 2.590 and 2.702 inclusive.

According to the above optical recording medium, by including a recording layer that includes at least Sb, Tb, and Te and is constructed so that when indexing as a hexagonal lattice has been performed in a state corresponding to the crystal phase, an axial ratio c/a of a c-axis length to an a-axis length in the hexagonal lattice is between 2.590 and 2.702 inclusive, it is possible to achieve an optical recording medium for which crystallization can be carried out reliably and for which a high transfer rate can be achieved while sufficiently maintaining the thermal stability of the amorphous state.

In this case, it is preferable that in the state corresponding to the crystal phase, the recording layer is constructed of a single phase with an A7 structure. By doing so, it is possible to suppress decreases in the crystallization speed due to phase separation, deterioration in the overwriting characteristics, deterioration in the storage characteristics due to precipitation of some of the elements, and the like. This makes it possible to increase the crystallization speed (the transfer rate) and to increase the storage stability.

The present application is based on Japanese Patent Application No. 2003-120205 filed on 24 Apr. 2003, the entire content of which is hereby incorporated by reference.

### BRIEF DESCRIPTION OF THE DRAWINGS

These and other objects and features of the present invention will be explained in more detail below with reference to the attached drawings, wherein:

FIG. 1 is a cross-sectional view showing the construction of an optical recording medium;

FIG. 2 is a cross-sectional view showing the construction of another optical recording medium;

FIG. 3 is a table showing the compositions of respective recording layers in first to seventh embodiments and first and second comparative examples;

FIG. 4 is a characteristics graph showing the relationship between a transfer rate and an erasure rate for the first to seventh embodiments and the first and second comparative examples;

FIG. 5 is an X-ray diffraction graph for samples 1 to 9 corresponding to the first to seventh embodiments and the first and second comparative examples;

FIG. 6 is a characteristics table showing the relationship between the respective Tb amounts, a-axis lengths, c-axis lengths, c/a axial ratios, and maximum transfer rates for the respective samples 1 to 9 corresponding to the first to seventh embodiments and the first and second comparative examples; and

FIG. 7 is a characteristics graph showing the relationship between the axial ratios and the transfer rates in FIG. 6.

### DESCRIPTION OF THE PREFERRED EMBODIMENTS

Preferred embodiments of an optical recording medium according to the present invention will now be described with reference to the attached drawings.

A recording layer for an optical recording medium according to the present invention includes at least Sb, Tb, and Te. When the recording layer is indexed as a hexagonal lattice in the state of the crystal phase, the axial ratio (c/a) of the c-axis length to the a-axis length in the hexagonal lattice is set as being 2.590 to 2.702 inclusive. By setting the axial ratio c/a in the stated range, compared to a recording layer with a face centered cubic structure where the structure of the crystal state is cubic (where the axial ratio c/a is 2.45), the high crystallization speed can be raised further and it is therefore possible to further increase the transfer rate of data. However, when the axial ratio c/a exceeds 2.702, there are the problems of a sudden drop in the crystallization speed (transfer rate) and a fall in the activation energy which causes a loss in thermal stability of the amorphous state. Also, if the axial ratio c/a is below 2.590, there is the problem that the crystallization speed is reduced. This means that it is preferable for the axial ratio c/a to be set in the above range, and by setting the axial ratio in this way, a sufficiently high thermal stability of the recording layer in the amorphous state can be achieved.

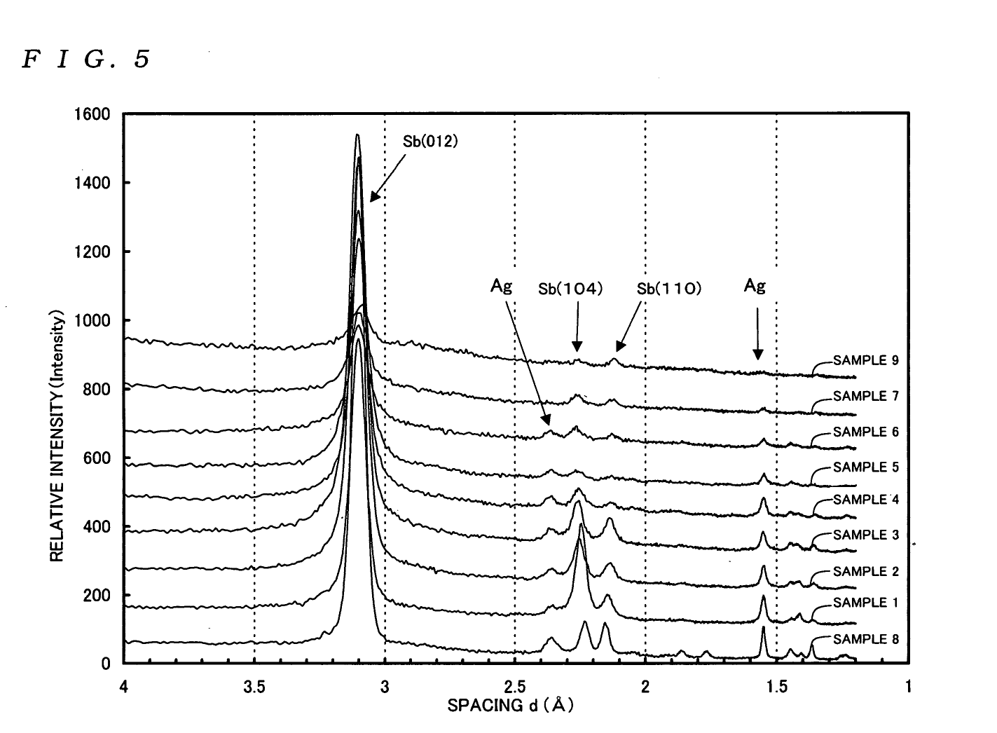

To calculate this axial ratio c/a, when X-ray diffraction has been carried out on the recording layer using Cu—Kα rays, for example, indexing as a hexagonal lattice is carried out based on the diffracted rays appearing in the X-ray diffraction graph, the c-axis length/the a-axis length is calculated in this hexagonal lattice based on the positions of the diffracted rays, and the result is set as the axial ratio c/a. Although there are no particular limitations regarding the diffracted rays used to calculate the axial ratio c/a, it is preferable to use a diffracted ray emanating from hexagonal (104) plane and a diffracted ray emanating from hexagonal (110) plane since the plane indices are different and adjacent diffraction peaks are obtained. It should be noted that when X-ray diffraction is carried out using the Cu—Kα rays mentioned above as one example, as shown in FIG. 5, the lattice plane corresponding to a diffracted ray present in a range of spacing d (Å) 3.10±0.03 is indexed as hexagonal (012) plane, the lattice plane corresponding to a diffracted ray present in a range of spacing d (Å) 2.25±0.03 is indexed as hexagonal (104) plane, and the lattice plane corresponding to a diffracted ray present in a range of spacing d (Å) 2.12±0.03 is indexed as hexagonal (110) plane.

In the state of the crystal phase, the recording layer of the optical recording medium of the present invention should preferably be composed of rhombohedral crystals of a single phase with an A7 structure. Such structure can be easily confirmed by comparing the numbers and positions of the diffracted rays that appear in the X-ray diffraction graph for the recording layer with a database such as JCPDS cards. More specifically, by comparing the numbers and positions of the diffracted rays that appear in the X-ray diffraction graph for the recording layer with the database mentioned above, when diffraction rays that show the presence of an A7 structure appear in only the ranges of the three spacings d (Å) described above, the recording layer can be determined as being composed of rhombohedral crystals of a single phase with an A7 structure. Here, the expression “single-phase” refers to a concept including a state wherein aside from Sb, the other elements Tb and Te are included in the recording layer, but these elements are in solid solution within the Sb lattice. In this way, by constructing a recording layer of single-phase rhombohedral crystals with an A7 structure in the crystal phase state, it is possible to suppress decreases in the crystallization speed due to phase separation, deterioration in the overwriting characteristics, deterioration in the storage characteristics due to precipitation of some of the elements, and the like. This makes it possible to increase the crystallization speed (the transfer rate) and to increase the storage stability.

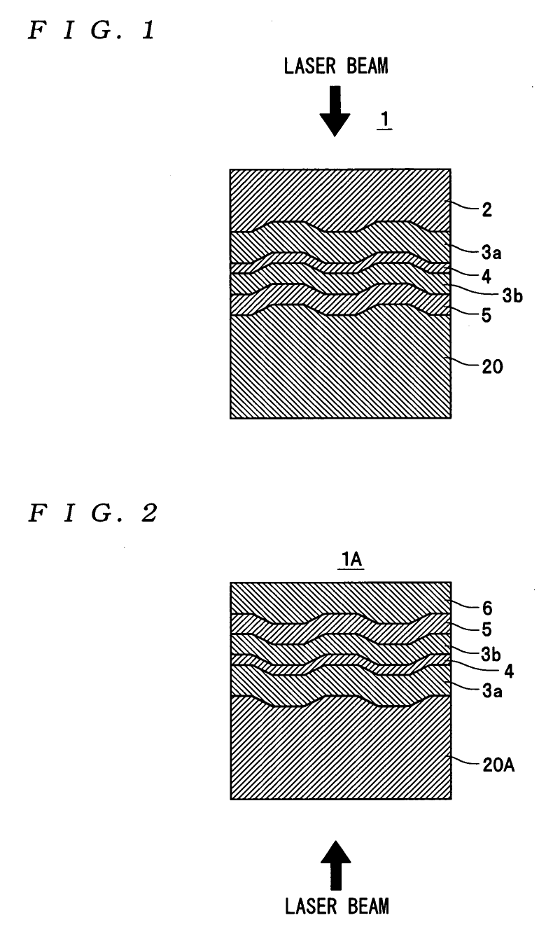

Aside from the composition of the recording layer, there are no particular limitations for the construction of an optical recording medium according to the present invention. As one example of the construction of a typical phase-change optical recording medium 1, as shown in FIG. 1, a reflective layer 6, a second dielectric layer 4b, a recording layer 5, a first dielectric layer 4a, a heat sink layer 3, and a light transmitting layer 2 may be successively formed in layers on a substrate 20. With this optical recording medium 1, laser beam is irradiated via the light transmitting layer 2 during recording and reproduction.

It is also possible to apply the present invention to an optical recording medium with the construction shown in FIG. 2. As shown in FIG. 2, a phase-change optical recording medium 1A of this example construction has a heat sink layer 3, a first dielectric layer 4a, a recording layer 5, a second dielectric layer 4b, a reflective layer 6, and a protective layer 7 successively formed in layers on a light transmitting substrate 20A. With this optical recording medium 1A, laser beam is irradiated via the light transmitting substrate 20A during recording and reproduction.

### EMBODIMENTS

The present invention will be described in detail below using several specific embodiments.

### First to Seventh Embodiments and First and Second Comparative Examples

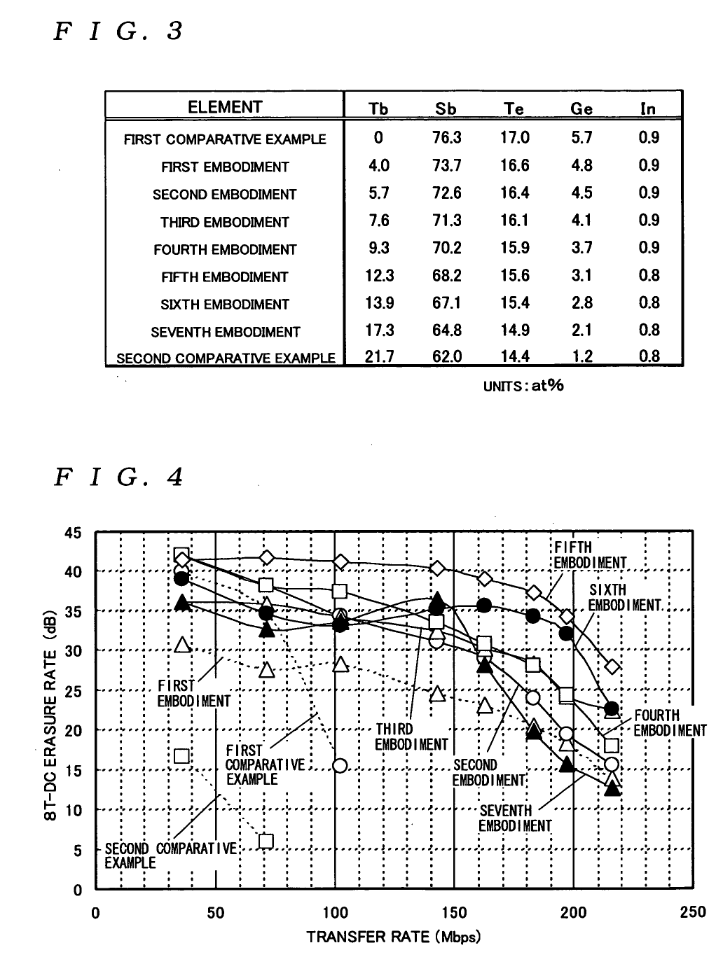

As the substrate 20, polycarbonate discs, which have a diameter of 120 mm and a thickness of 1.1 mm, are formed by injection molding. Grooves are simultaneously formed in these discs. A plurality of optical recording media were manufactured by successively forming the reflective layer 6, the second dielectric layer 4b, the recording layer 5, the first dielectric layer 4a, the heat sink layer 3, and the light transmitting layer 2 in layers on the surfaces of these discs as shown in FIG. 1. In this case, the first to seventh embodiments and the first and second comparative examples were produced by varying the Sb, Tb, and Te composition in the recording layers 5 of the respective optical recording media as shown in FIG. 3, with the values in the chart being atomic percentages (at%).

In this case, the reflective layer 6 is formed by sputtering in an Ar atmosphere. A ratio for Ag, Pd, and Cu of 98:1:1 was used in the target. The thickness of the reflective layer 6 was set at 100 nm.

The second dielectric layer 4b was formed by sputtering in an Ar and N₂ atmosphere using an Al target. The thickness of the second dielectric layer 4b was set at 4 nm. The recording layer 5 was formed by two-element sputtering in an Ar atmosphere using targets of InSbTeGe and Tb as the target. The thickness of the recording layer 5 was set at 14 nm. The first dielectric layer 4a was formed by sputtering in an Ar atmosphere using a ZnS (80 mol %)−SiO₂(20 mol %) target. The thickness of the first dielectric layer 4a was set at 30 nm. The heat sink layer 3 was formed by sputtering in an Ar and N₂ atmosphere using an Al target. The thickness of the heat sink layer 3 was set at 100 nm. The light transmitting layer 2 was formed via spin coating using a UV-curing acrylic resin. The thickness of the light transmitting layer 2 was set at 0.1 mm.

Next, the respective recording layers 5 of the optical recording media of the first to seventh embodiments and the first and second comparative examples were initialized (crystallized) using a bulk eraser. Next, at the following conditions—laser wavelength=405 nm, numerical aperture NA=0.85, modulation method=(1, 7) RLL, channel bit length=0.12 μm/bit, and format efficiency=81.7%—the transfer rate for erasing (the linear velocity, that is, the irradiation time of the laser spot) was varied, and the erasure rate for a case where 8T marks are erased with a DC erasing power (hereinafter this rate is called the “8T-DC erasure rate” and is expressed in dB units) was measured for each transfer rate. The relationship between the transfer rate and the erasure rate for the optical recording media of the first to seventh embodiments and the first and second comparative examples is shown in FIG. 4.

As shown in FIG. 4, although 25 dB, which is a benchmark erasure rate for rewriting, can be realized with the optical recording medium of the first comparative example at transfer rates below 90 Mbps, when the transfer rate is 90 Mbps or above, the erasure rate rapidly falls below 25 dB. As a result, it was confirmed that for the optical recording medium of the first comparative example, it was not possible to record and erase information in a region where the transfer rate exceeds 100 Mbps. Also, with the optical recording medium of the second comparative example, it is not possible to achieve the benchmark erasure rate of 25 dB for rewriting even at transfer rates below 90 Mbps. From these results, it was confirmed that with the optical recording medium of the second comparative example, it is not possible to record and erase information at the high transfer rates (transfer rates above 100 Mbps) expected for the embodiments of the present invention. On the other hand, it was confirmed for the first to seventh embodiments that a sufficient erasure rate of 25 dB or above can be maintained for a transfer rate of at least 136 Mbps. In addition, it was confirmed for the second to seventh embodiments that a sufficient erasure rate 25 dB or above can be maintained up to a transfer rate of at least 170 Mbps. For the fifth and sixth embodiments in particular, it was confirmed that a sufficient erasure rate of 25 dB or above can be maintained even at transfer rates of over 200 Mbps.

Samples 1 to 9 for X-ray diffraction analysis were also manufactured corresponding to the optical recording media of the first to seventh embodiments and the first and second comparative examples. As these samples, optical recording media 1 of the first to seventh embodiments and the first and second comparative examples were initialized and then the respective light transmitting layers 2, the heat sink layers 3, and the first dielectric layers 4a were stripped off to expose the recording layers 5, the surfaces of which were set as the analysis surfaces. In this X-ray diffraction analysis, a thin-film analyzing X-ray diffractometer (the “ATX-G” model manufactured by RIGAKU CORPORATION) was used as the source for Cu—Kα rays. The relationship between the spacings d (Å) and the intensity of the diffracted rays is shown for the samples 1 to 9 in FIG. 5.

According to FIG. 5, with all the samples 1 to 9, one diffracted ray appears in each of the respective ranges of a spacing d=3.10±0.03, a spacing d=2.25±0.03, and a spacing d=2.12±0.03. By comparing these diffracted rays with JCPDS cards, in order starting with the widest spacing d, the diffracted rays were identified as rays emanating from (012) plane, (104) plane and (110) plane of an Sb structure in hexagonal notation. From these results, it was confirmed that the crystallized recording layer 5 in each of the samples 1 to 9 was composed of a single phase with an Sb structure. In addition, some diffraction peaks were also detected from the reflective layer 6 below the recording layer 5.

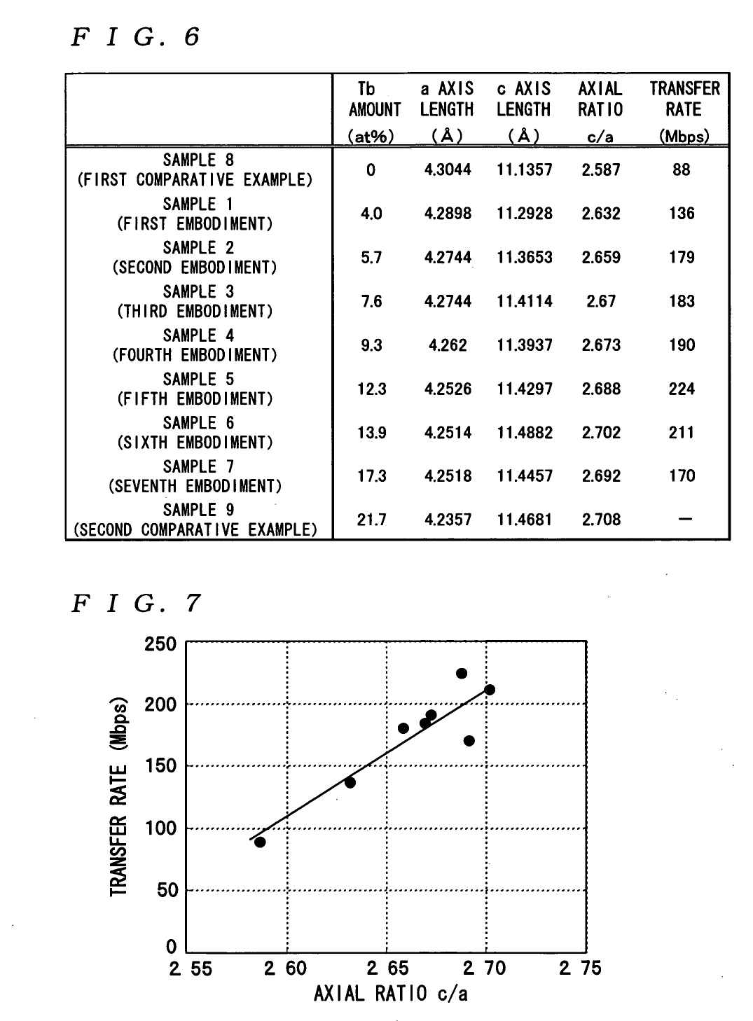

Next, the diffracted rays appearing in the diffraction graphs for samples 1 to 9 were indexed as hexagonal lattices, the a-axis length and the c-axis length were found from the diffracted rays emanating from the hexagonal (104) plane and the hexagonal (110) plane, and the axial ratios c/a of the c-axis length to the a-axis length in the respective samples 1 to 9, which is to say, the axial ratios c/a of the c-axis length to the a-axis length in the first to seventh embodiments and the first and second comparative examples, were found from these axis lengths. Also, based on the results in FIG. 4, a maximum transfer rate at which a sufficient erasure rate of 25 dB or higher can be maintained was found for the first to seventh embodiments and the first and second comparative examples. The respective Tb amounts, a-axis lengths, c-axis lengths, c/a axial ratios, and maximum transfer rates for respective samples 1 to 9 (the first to seventh embodiments and the first and second comparative examples) are shown in FIG. 6. The relationship between the axial ratios c/a shown in FIG. 6 and the transfer rates is shown in FIG. 7.

From FIGS. 6 and 7, it was confirmed that there is a tendency for the transfer rate to increase as the axial ratio c/a increases, at least in a range where the axial ratio c/a is between 2.587 and 2.702 inclusive. It was also confirmed that the transfer rate exceeds 100 Mbps when the axial ratio c/a is 2.59 or above. When the axial ratio c/a is above 2.702, it was confirmed that the transfer rate rapidly falls below 100 Mbps.

When all the comparison results for optical recording media of the first to seventh embodiments and the first and second comparative examples shown in FIGS. 4 and 7 and the respective samples 1 to 9 corresponding to these media are collated, it was confirmed that a sufficient erasure rate of 25 dB or above can be achieved at transfer rate of at least above 100 Mbps with an optical recording medium including a recording layer which includes at least Sb, Tb, and Te, for which diffracted rays emanating from (012) plane, (104) plane, and (110) plane of an Sb structure in hexagonal notation are present in each of the respective ranges of a spacing d=3.10±0.03, a spacing d=2.25±0.03, and a spacing d=2.12±0.03 when X-ray diffraction analysis is carried out for the crystal phase, and for which the axial ratio c/a is between 2.587 and 2.702 inclusive. In addition, it was confirmed that an optical recording medium with a recording layer where the axial ratio c/a is 2.64 to 2.702 inclusive, is preferable since a sufficient erasure rate of 25 dB or above can be maintained at transfer rates in excess of 150 Mbps. In particular, for optical recording media with a recording layer where the axial ratio c/a is 2.68 to 2.702 inclusive, it was confirmed that a sufficient erasure rate of 25 dB or above can be maintained at transfer rates in excess of 200 Mbps.

The reason for the tendency of the transfer rate to increase as the axial ratio c/a increases in at least a range where the axial ratio c/a is 2.587 to 2.702 inclusive, is thought to be as follows. In a rhombic structure, the constitutional atoms are arranged in layers in the overall structure due to the atoms being arranged in parallel on a plurality of planes perpendicular to the c-axis. In this case, the phase change between the crystal phase and the amorphous phase, that is, the rearranging of the atoms is thought to occur within the planes described above. On the other hand, when the axial ratio becomes large, the a-axis parallel to these planes becomes shorter and the c-axis becomes longer. This means that the interatomic distances become shorter due to the gaps between atoms arranged on the planes becoming shorter, so that the distances moved when the atoms are rearranged become shorter. Accordingly, it is thought that since the rearranging of the atoms is completed in a short time, the time taken for crystallization is reduced (i.e., the crystallization speed is increased), which results in a high transfer rate being achieved. Also, since the recording layer is constructed of rhombic crystals composed of a single phase with an A7 structure, it becomes easy for atoms to move within the planes described above, so that it is possible to suppress decreases in the crystallization speed due to phase separation, deterioration in the overwriting characteristics, deterioration in the storage characteristics due to precipitation of some of the elements, and the like. This makes it possible to increase the crystallization speed (the transfer rate) and to further increase the storage stability.

The present inventors also performed archival stability tests (experiments where a recorded signal is stored for a predetermined time and then reproduced and evaluated under the same conditions as the measurement of the 8T-DC erasure rate described above, with the conditions for the experiments being a temperature of 80° C. and a “dry” humidity level (i.e., 10% or below)) for optical recording media where the axial ratio c/a is in a range of 2.59 to 2.702 inclusive. According to these experiments, it was confirmed that even when the information is stored for a long time (as examples, for periods up to 200 hours, such as 25 hours, 50 hours, and 150 hours), deterioration is suppressed to within 1%, such as a deterioration where jitter increases from 9% to around 9.5%, which presents no problem whatsoever in actual use. Archival stability tests were also performed under the same conditions after performing multispeed recording at transfer rates of 100 Mbps, 140 Mbps, and 200 Mbps. According to these experiments, it was confirmed that the increase in jitter was suppressed to within 1% for each of the transfer rates, which presents no problem whatsoever in actual use.

1. An optical recording medium that includes a phase-change recording layer where reversible phase changes between a crystal phase and an amorphous phase are used,
wherein the recording layer includes at least Sb, Tb, and Te and when indexing as a hexagonal lattice has been performed in a state corresponding to the crystal phase, the recording layer has a structure where an axial ratio c/a of a c-axis length to an a-axis length in the hexagonal lattice is between 2.590 and 2.702 inclusive.

2. An optical recording medium according to claim 1, wherein in the state corresponding to the crystal phase, the recording layer is constructed of a single phase with an A7 structure.
